(19) United States
(12) Patent Application Publication
(10) Pub. No.: US 2024/0264132 A1
(43) Pub. Date: Aug. 8, 2024

(54) WAVEFORM SHAPE LEARNING DEVICE, WAVEFORM SHAPE LEARNING METHOD, NON-TRANSITORY COMPUTER READABLE MEDIUM STORING WAVEFORM SHAPE LEARNING PROGRAM AND MODEL FUNCTION ESTIMATION DEVICE

(71) Applicant: SHIMADZU CORPORATION, Kyoto-shi (JP)

(72) Inventor: Akira NODA, Kyoto-shi (JP)

(21) Appl. No.: 18/434,524

(22) Filed: Feb. 6, 2024

(30) Foreign Application Priority Data
Feb. 8, 2023 (JP) 2023-017965

(51) Int. Cl. G01N 30/86

(52) U.S. Cl. CPC G01N 30/8693; G01N 30/8637; G01N 30/8651

(57) ABSTRACT

A waveform shape learning device learns a waveform of a sample using measurement data of the sample, the measurement data being obtained in an analysis device, and includes an extractor that retrieves the measurement data stored in a storage device and extracts input data from the measurement data, a latent variable generator that outputs, based on the input data, a latent variable by which the input data is characterized, a waveform data generator that outputs waveform data based on the latent variable and stores the waveform data in the storage device, a comparer that compares, using a loss function, the input data and the waveform data that are stored in the storage device, and a trainer that optimizes the latent variable generator and the waveform data generator so that output of the loss function is minimized.

### BACKGROUND

### Technical Field

The present disclosure relates to a technique for learning a waveform of measurement data acquired in an analysis device and a technique for estimating a model function fitted to measurement data by using the trained device.

### Description of Related Art

In measurement data obtained from an analysis device such as a liquid chromatograph, a gas chromatograph or a mass spectrometer, a peak of a sample is observed. For example, in WO 2016/035167 A1, a peak position of a sample, a peak area of a sample and the like are obtained by fitting of a model function to a waveform included in the measurement data. Further, in WO 2021/210228 A1, a model function representing a peak waveform can be generated using an adversarial generative model.

### SUMMARY

With the method disclosed in WO 2021/210228 A1, machine learning using actually measured measurement data is performed, and a generative model of a waveform data can be constructed. Further, it is expected that a more convenient generative model can be constructed by realization of a method of accurately learning measurement data.

An object of the present disclosure is to construct a highly convenient generative model of waveform data by appropriately learning measurement data.

A waveform shape learning device according to one aspect of the present disclosure that learns a waveform of a sample using measurement data of the sample, the measurement data being obtained in an analysis device, includes an extractor that retrieves the measurement data stored in a storage device and extracts input data from the measurement data, a latent variable generator that outputs, based on the input data, a latent variable by which the input data is characterized, a waveform data generator that outputs waveform data based on the latent variable and stores the waveform data in the storage device, a comparer that compares, using a loss function, the input data and the waveform data that are stored in the storage device, and a trainer that optimizes the latent variable generator and the waveform data generator so that output of the loss function is minimized.

A model function estimation device according to another aspect of the present disclosure estimates, using the waveform data generator that has been trained in the waveform shape learning device, a model function of measurement data subject to estimation, wherein the waveform data generator outputs, based on the latent variable provided as a prior distribution, the waveform data, and the model function estimation device fits the waveform data to the measurement data subject to estimation by optimizing the latent variable.

The present disclosure is also directed to a waveform shape learning method and a waveform shape learning program.

With the present disclosure, it is possible to construct a highly convenient generative model of waveform data by appropriately learning measurement data.

Other features, elements, characteristics, and advantages of the present disclosure will become more apparent from the following description of preferred embodiments of the present disclosure with reference to the attached drawings.

### BRIEF DESCRIPTION OF THE DRAWING

FIG. 1 is a diagram showing the configuration of a waveform shape learning device (model function estimation device) according to the present embodiment;

FIG. 2 is a block diagram showing the functions of the waveform shape learning device according to the embodiment;

FIG. 3 is a block diagram showing a flow of a process of a waveform shape learning device according to a first embodiment;

FIG. 4 is a block diagram showing a flow of a process of a waveform shape learning device according to a second embodiment;

FIG. 5 is a block diagram showing a flow of a process of a waveform shape learning device according to a third embodiment;

FIG. 6 is a flowchart showing a waveform shape learning method according to the first embodiment;

FIG. 7 is a flowchart showing a waveform shape learning method according to the second embodiment;

FIG. 8 is a flowchart showing a waveform shape learning method according to the third embodiment;

FIG. 9 is a diagram showing measurement data for learning including a peak shape;

FIG. 10 is a diagram showing waveform data generated using a generative model that has been trained using a GAN; and

FIG. 11 is a diagram showing waveform data generated using a generative model that has been trained using the GAN and has caused mode collapse.

### DETAILED DESCRIPTION

A waveform shape learning device, a waveform shape learning method, a waveform shape learning program and a model function estimation device according to embodiments of the present disclosure will now be described with reference to the attached drawings.

### 1. CONFIGURATION OF WAVEFORM SHAPE LEARNING DEVICE

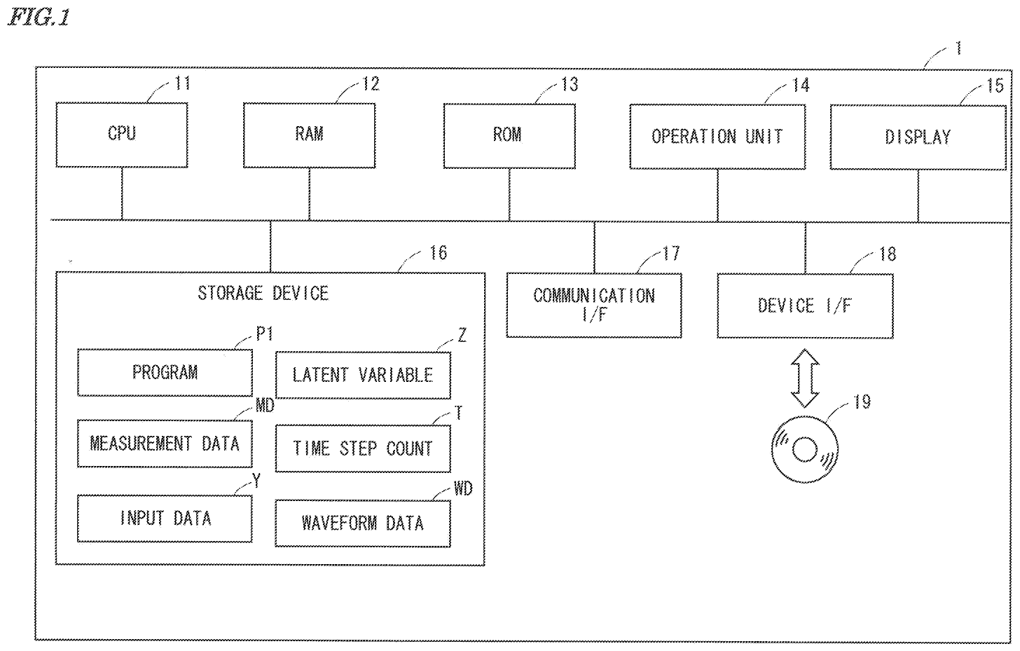

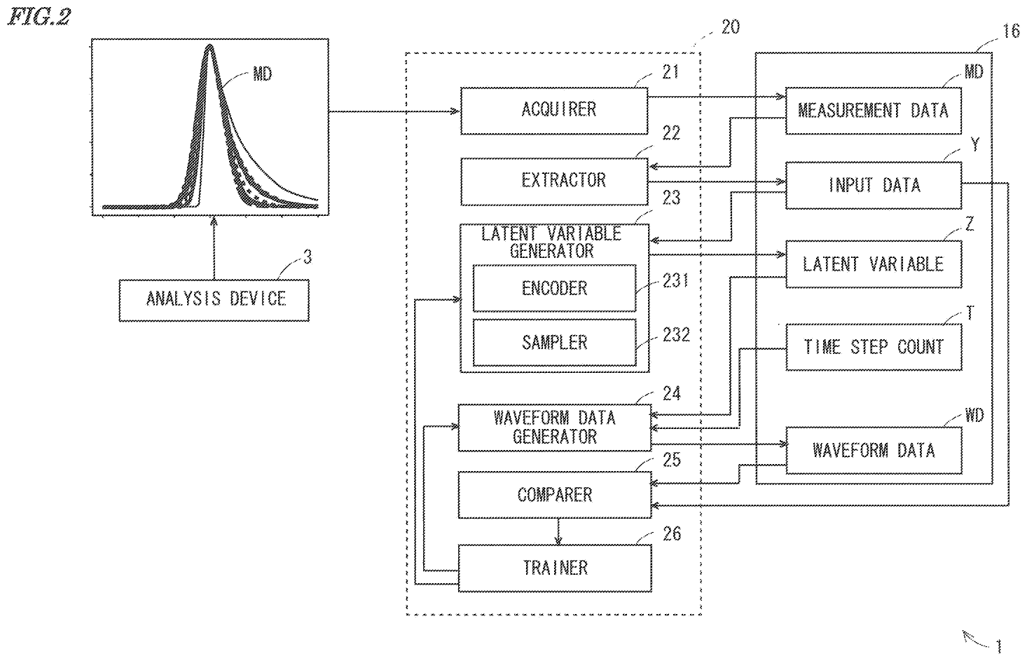

FIG. 1 is a diagram showing the configuration of a waveform shape learning device 1 according to an embodiment. The waveform shape learning device 1 of the present embodiment also functions as a model function estimation device. FIG. 1 shows the configuration common to the first to third embodiments. The waveform shape learning device 1 acquires measurement data MD of a sample obtained in an analysis device 3 (see FIG. 2) such as a liquid chromatograph, a gas chromatograph or a mass spectrometer.

The waveform shape learning device 1 of the present embodiment is constituted by a computer such as a personal computer. As shown in FIG. 1, the waveform shape learning device 1 includes a CPU (Central Processing Unit) 11, a RAM (Random Access Memory) 12, a ROM (Read Only Memory) 13, an operation unit 14, a display 15, a storage device 16, a communication interface (I/F) 17 and a device interface (I/F) 18.

The CPU 11 controls the waveform shape learning device 1 as a whole. The RAM 12 is used as a work area for execution of a program by the CPU 11. Various data, a program and the like are stored in the ROM 13. The operation unit 14 receives an input operation performed by a user. The operation unit 14 includes a keyboard, a mouse, etc. The display 15 displays various information such as a waveform shape. The storage device 16 is a storage medium such as a hard disc. The storage device 16 stores a program P1, measurement data MD, input data Y, a latent variable Z, a time step count T and waveform data WD.

The communication interface 17 is an interface that communicates with another computer through wireless or wired communication. The device interface 18 is an interface that accesses a storage medium 19 such as a CD, a DVD or a semiconductor memory.

### 2. FUNCTIONAL CONFIGURATION OF DEVICE

FIG. 2 is a diagram showing the functional configuration of the waveform shape learning device 1 according to the embodiment. FIG. 2 shows the configuration common to the first to third embodiments. In FIG. 2, a controller 20 is a function that is implemented by execution of the program P1 by the CPU 11 while the CPU 11 uses the RAM 12 as a work area. The controller 20 includes an acquirer 21, an extractor 22, a latent variable generator 23, a waveform data generator 24, a comparer 25 and a trainer 26. That is, the acquirer 21, the extractor 22, the latent variable generator 23, the waveform data generator (decoder) 24, the comparer 25 and the trainer 26 are the functions implemented by execution of the program P1. In other words, each of the functions 21 to 26 is a function included in the CPU 11.

The acquirer 21 acquires measurement data MD acquired by measurement of a sample using the analysis device 3. The acquirer 21 receives the measurement data MD from the analysis device 3 such as a liquid chromatograph, a gas chromatograph or a mass spectrometer, or another computer via the communication interface 17, for example. Alternatively, the acquirer 21 acquires the measurement data MD stored in the storage medium 19 via the device interface 18. The acquirer 21 stores the acquired measurement data MD in the storage device 16.

The extractor 22 extracts input data Y from the measurement data MD. The input data Y is the data to be learned. The input data Y is time-series data representing a waveform of a peak portion which is extracted from the measurement data MD. In regard to the input data Y to be used for learning, it is preferable to remove a peak having an extremely low SN ratio or a peak that is insufficiently separated, and extract a peak having a good waveform shape.

The latent variable generator 23 includes an encoder 231 and a sampler 232. The latent variable generator 23 receives the input data Y and outputs a latent variable Z. The encoder 231 is configured as a neural network that is trained by machine learning. The encoder 231 outputs distribution information as a feature in a latent space. The distribution information is a mean value or a variance by which the output of the encoder 231 is characterized as a normal distribution, for example. In this case, the encoder 231 is a neural network that outputs two-dimensional data of the mean value and the variance.

The sampler 232 samples the latent variable Z based on the feature in the latent space, the feature being the output of the encoder 231. In a case in which the latent space is characterized as a normal distribution, the sampler 232 outputs the latent variable Z as a random number with a probability based on the normal distribution. The latent variable Z is normally the data having the smaller number of dimensions than that of the input data Y. For example, input data Y which is 200 dimensional time-series data is reduced in dimension to a latent variable Z of a low dimension such as 4 dimensions.

The waveform data generator 24 receives the latent variable Z and outputs waveform data WD. The waveform data generator 24 is a neural network constructed for the purpose of generation of data similar to the input data Y. The waveform data WD is the time-series data having the same number of dimensions as that of the input data Y. For example, in a case in which the input data Y is 200 dimensional time-series data, the waveform data WD is also output as 200 dimensional time-series data.

The comparer 25 compares the input data Y with the waveform data WD. The comparer 25 outputs the error between the input data Y and the waveform data WD using a loss function. For example, the comparer 25 obtains the mean square error between the input data Y and the waveform data WD by using a loss function. Based on a value of the loss function output from the comparer 25, the trainer 26 trains the encoder 231 and the waveform data generator 24 using a method such as backpropagation or stochastic gradient descent. That is, parameters (weights) of the encoder 231 and the waveform data generator 24 configured as neural networks are updated for minimization of a value of the loss function.

The program P1 is stored in the storage device 16, by way of example. In another embodiment, the program P1 may be provided in the form of being stored in the storage medium 19. The CPU 11 may access the storage medium 19 via the device interface 18 and may store the program P1 stored in the storage medium 19, in the storage device 16 or the ROM 13. Alternatively, the CPU 11 may access the storage medium 19 via the device interface 18 and may execute the program P1 stored in the storage medium 19. Alternatively, the CPU 11 may download the program P1 stored in a server on a network via the communication interface 17. Alternatively, the CPU 11 may execute the program P1 stored in the server on the network via the communication interface 17.

### 3. FIRST EMBODIMENT

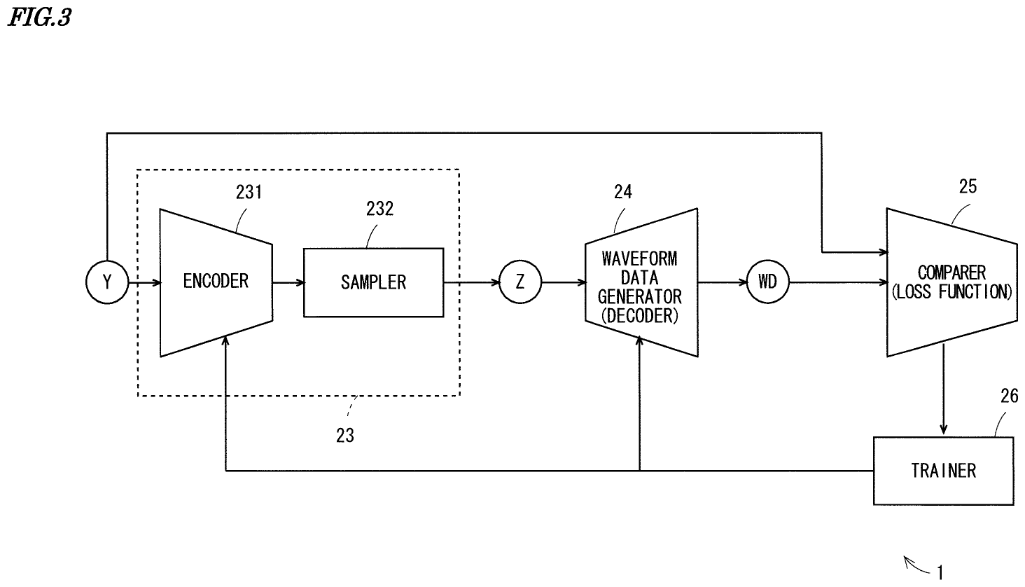

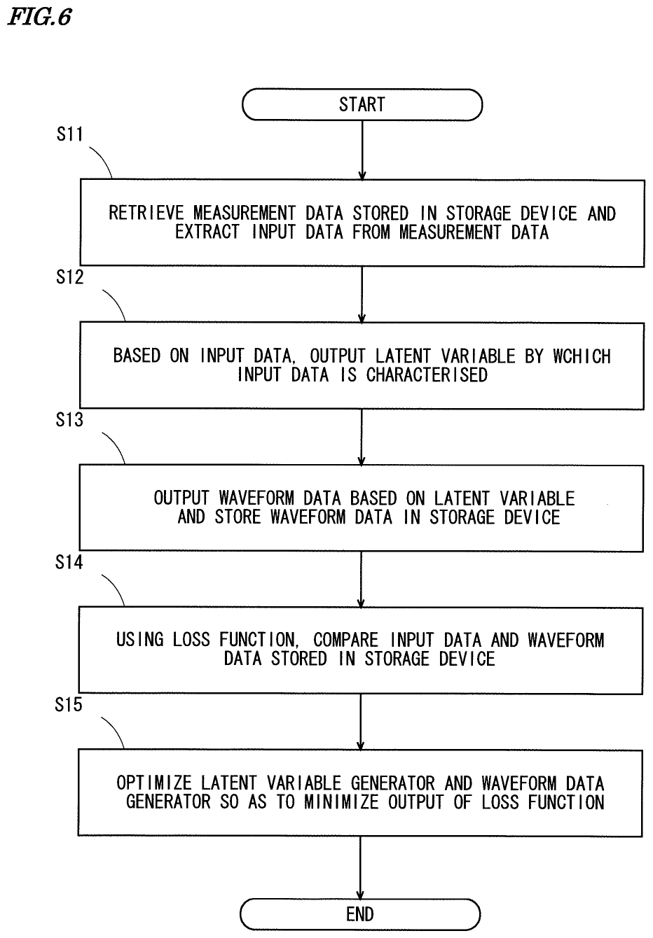

A waveform shape learning device 1 according to a first embodiment will be described next with reference to FIGS. 3 and 6. FIG. 3 is a diagram showing a flow of a process of the waveform shape learning device 1 according to the first embodiment. FIG. 6 is a flowchart showing a waveform shape learning method according to the first embodiment. The processes shown in the flowchart of FIG. 6 are the processes to be executed by the CPU 11 shown in FIG. 1. That is, these processes are executed by each of the functions 21 to 26 shown in FIG. 2 when the CPU 11 runs the program P1 while using the hardware resources such as the RAM 12.

Reference is made to the flowchart of FIG. 6. In the step S11, the extractor 22 retrieves measurement data MD stored in the storage device 16 and extracts input data Y from the measurement data MD. The extractor 22 stores the input data Y in the storage device 16.

Next, in the step S12, the latent variable generator 23 outputs a latent variable Z by which the input data Y is characterized based on the input data Y. Specifically, the encoder 231 outputs distribution information of a latent space based on the input data Y, and the sampler 232 samples the latent variable Z based on the distribution information of the latent space.

Next, in the step S13, the waveform data generator 24 outputs waveform data WD based on the latent variable Z. The waveform data generator 24 stores the generated waveform data WD in the storage device 16.

Next, in the step S14, the comparer 25 compares the input data Y and the waveform data WD that are stored in the storage device 16 using a loss function. Using the loss function, the comparer 25 obtains the error between the input data Y and the waveform data WD which are time-series data pieces having the same number of dimensions.

Next, in the step S15, the trainer 26 optimizes the latent variable generator 23 and the waveform data generator 24 so as to minimize the output of the loss function that has been output from the comparer 25. Using backpropagation, for example, the trainer 26 adjusts the parameters of the encoder 231 and the waveform data generator 24 that are configured as neural networks. A learning process in the waveform shape learning device 1 is completed with the above-mentioned process.

### 4. SECOND EMBODIMENT

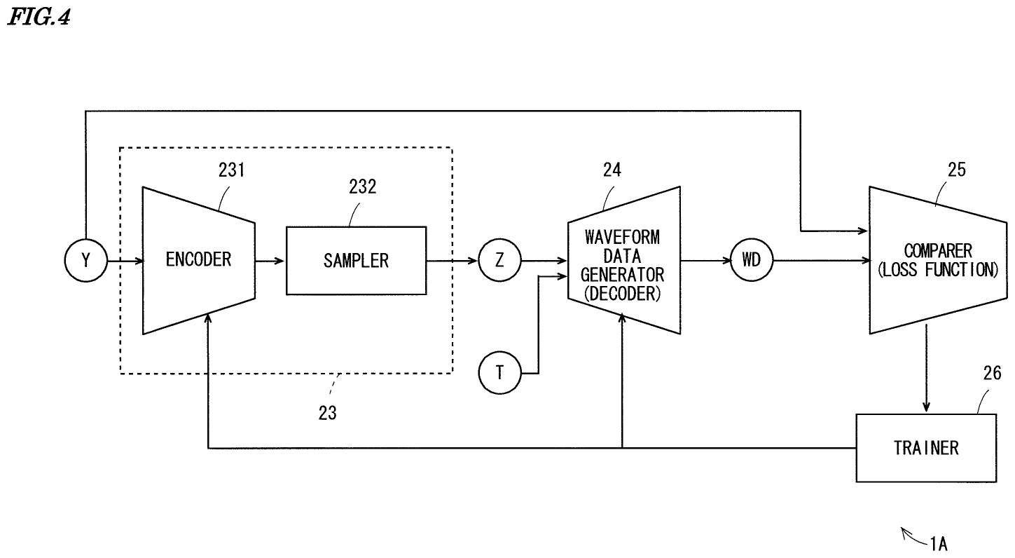

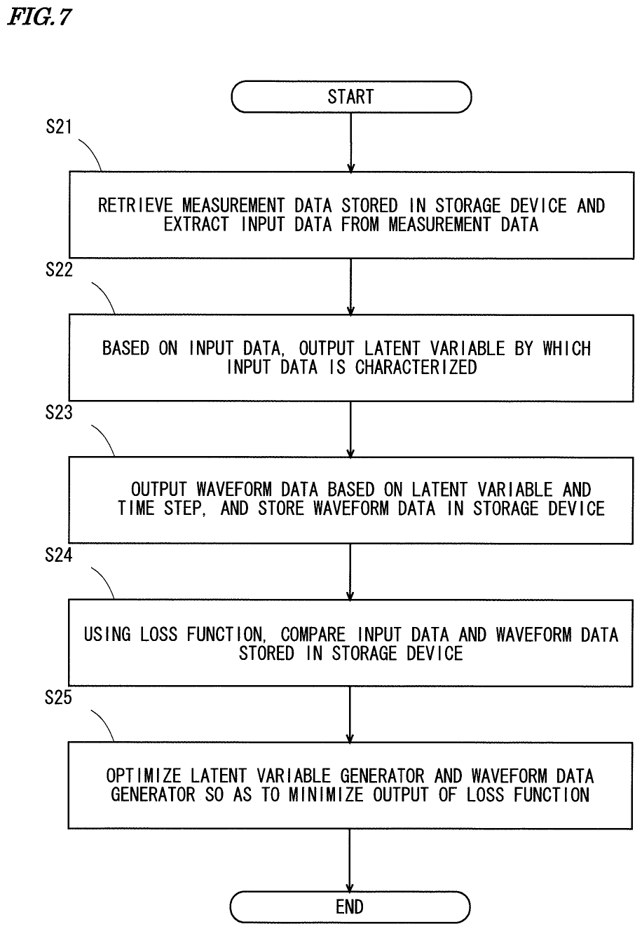

A waveform shape learning device 1A according to a second embodiment will be described next with reference to FIGS. 4 and 7. FIG. 4 is a diagram showing a flow of a process of the waveform shape learning device 1A according to the second embodiment. FIG. 7 is a flowchart showing a waveform shape learning method according to the second embodiment. As shown in FIG. 4, the waveform data generator 24 receives a time step count T together with a latent variable Z. The time step count T is a value for making the number of dimensions of input data Y and waveform data WD be the same.

Reference is made to the flowchart of FIG. 7. The steps S21 and S22 are similar to the steps S11 and S12 in FIG. 6. Therefore, a description thereof will not be repeated.

Next, in the step S23, the waveform data generator 24 outputs the waveform data WD based on a latent variable Z and a time step count T. Due to designation of the time step count T, the waveform data generator 24 outputs the waveform data WD as the time-series data of T dimensions. By designating the time step count T, the waveform data generator 24 can make the number of dimensions of the waveform data WD to be output be variable. The waveform data generator 24 stores the generated waveform data WD in the storage device 16.

The steps S24 and S25 are similar to the steps S14 and S15 in FIG. 6. Therefore, a description thereof will not be repeated. The learning process in the waveform shape learning device 1 is completed with the above-mentioned process. The waveform data generator 24 that has been trained in the waveform shape learning device 1A according to the second embodiment can output, because of the setting of the time step count T, the waveform data WD as time-series data of any number of dimensions.

### 5. THIRD EMBODIMENT

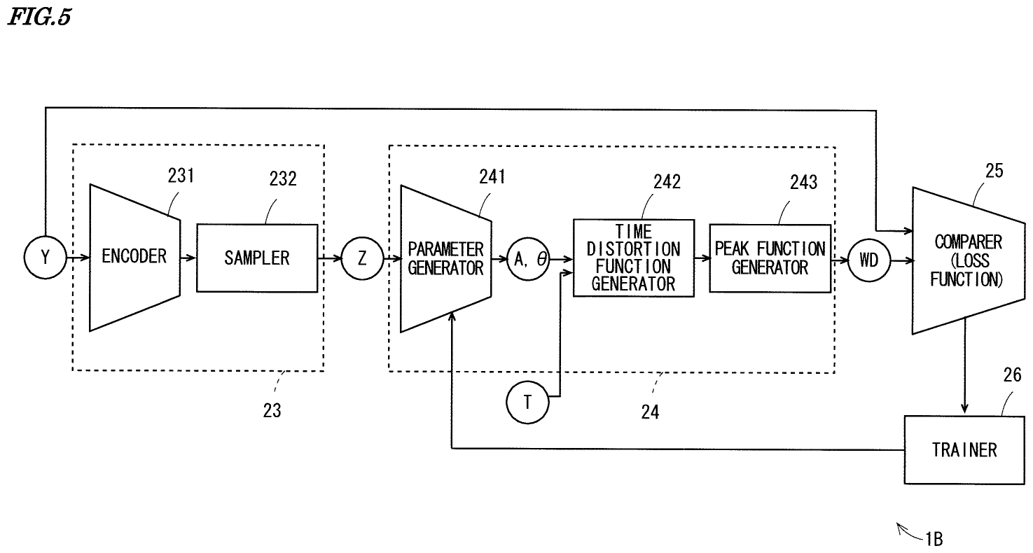

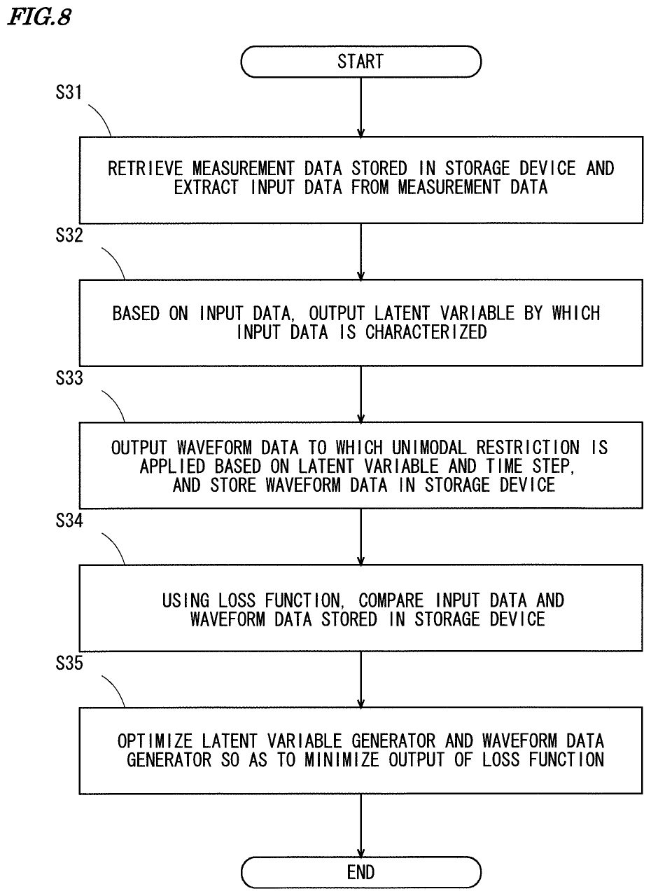

A waveform shape learning device 1B according to a third embodiment will be described next with reference to FIGS. 5 and 8. FIG. 5 is a diagram showing a flow of a process of the waveform shape learning device 1B according to the third embodiment. FIG. 8 is a flowchart showing a waveform shape learning method according to the third embodiment. As shown in FIG. 5, the waveform data generator 24 includes a parameter generator 241, a time distortion function generator 242 and a peak function generator 243. The time distortion function generator 242 receives a time step count T together with the parameters A, θ. The time step count T is a value for making the number of dimensions of input data Y and the number of dimensions of waveform data WD be the same.

The parameter generator 241 is a neural network that receives a latent variable Z and outputs the parameters A, θ. The parameters A(Z), θ(Z) are parameters for defining the time distortion function. The parameter generator 241 outputs N parameters A(Z)_1, A(Z)_2, . . . and A(Z)_N as the parameter A(Z), and outputs N parameters θ(Z)_1, θ(Z)_2, . . . and θ(Z)_N as the parameter θ(Z).

The time distortion function generator 242 is a processing unit that receives the parameters A(Z), θ(Z) and the time step count T, and outputs a time distortion function D(t, Z). The time distortion function generator 242 calculates the time distortion function D(t, Z) using the following formula 1.

$$D ( t , Z ) = \sum A\_i ( Z ) * f\_i ( t , θ\_i ( Z ) ) \qquad ( formula 1 )$$

In the formula 1, i=1, 2, . . . N, and i is an index of a sigmoid function that forms the time distortion function D(t, Z). f_i(*) represents a sigmoid function. t in f_i(t, θ_i (Z)) is a period of time corresponding to the number of dimensions determined based on the time step count T. For example, in a case in which 200 dimensions are designated as the time step count T, t=0, 1, . . . 199, and f_i(t, θ_i(Z)) is the time-series data of 200 dimensions. The time distortion function D(t, Z) obtained using the formula 1 is a function obtained when N sigmoid functions are added, and the shape of each sigmoid function f_i(*) is characterized by the parameters A_i(Z) and θ_i(Z). The time distortion function D(t, Z) is a monotonically increasing function.

The peak function generator 243, based on the time distortion function D(t, Z) calculated by the time distortion function generator 242, calculates the following formula 2, thereby obtaining a function F(t, Z) representing the waveform data WD.

$$F ( t , Z ) = A ( Z ) * exp ( - {D ( t , Z )}^{2} ) \qquad ( formula 2 )$$

In the formula 2, A(Z) represents a peak height. Because D(t, Z) is a monotonically increasing function, exp(−D(t, Z)²) represents a peak waveform. That is, a unimodal restriction is applied to the function F(t, Z).

Reference is made to the flowchart of FIG. 8. The steps S31 and S32 are similar to the steps S11 and S12 in FIG. 6. Therefore, a description thereof will not be repeated.

Next, in the step S33, the waveform data generator 24 outputs the waveform data WD to which a unimodal restriction is applied based on the latent variable Z and the time step count T. Due to designation of the time step count T, the number of dimensions of the waveform data WD is T. By designating the time step count T, the waveform data generator 24 can make the number of dimensions of the waveform data WD to be output be variable. The waveform data generator 24 stores the generated waveform data WD in the storage device 16.

The steps S34 and S35 are similar to the steps S14 and S15 in FIG. 6. Therefore, a description thereof will not be repeated. The learning process in the waveform shape learning device 1B is completed with the above-mentioned process. The waveform data generator 24 that has been trained in the waveform shape learning device 1B in the third embodiment can output, because of the setting of the time step count T, the waveform data WD as time series data of any number of dimensions. The waveform shape learning device 1B in the third embodiment can apply a unimodal restriction to the waveform data WD.

### 6. MODEL FUNCTION ESTIMATION DEVICE

Next, a model function estimation device according to the present embodiment will be described. The model function estimation device includes the waveform data generator 24 that has been trained in each of the waveform shape learning devices 1, 1A, 1B according to each of the above-mentioned embodiments. Each of the waveform shape learning devices 1, 1A, 1B may be utilized as a model function estimation device. In this case, each of the waveform shape learning devices 1, 1A, 1B further includes an estimator that performs Bayesian inference or the like in order to function as a model function estimation device. In the model function estimation device, it is possible to generate waveform data WD by providing an appropriate latent variable Z to the waveform data generator 24.

For example, a method of fitting a model function to another measurement data MD that is subject to estimation and acquired from the analysis device 3 will be described. First, an appropriate latent variable Z is provided to the waveform data generator 24, and waveform data WD is generated. By using Bayesian inference or a least squares method, the model function estimation device fits the waveform data WD output from the waveform data generator 24 to the measurement data MD subject to estimation. In a case in which Bayesian inference is used, the latent variable Z to be provided to the waveform data generator 24 can be set as a prior distribution.

As described above, in the second and third embodiments, the waveform data generator 24 can output, because of the setting of the time step count T, the waveform data WD as time series data of any number of dimensions. Thus, the waveform data generator 24 that has been trained in the second and third embodiments can generate waveform data WD that is time-series data of any number of dimensions, and is therefore highly convenient for peak fitting.

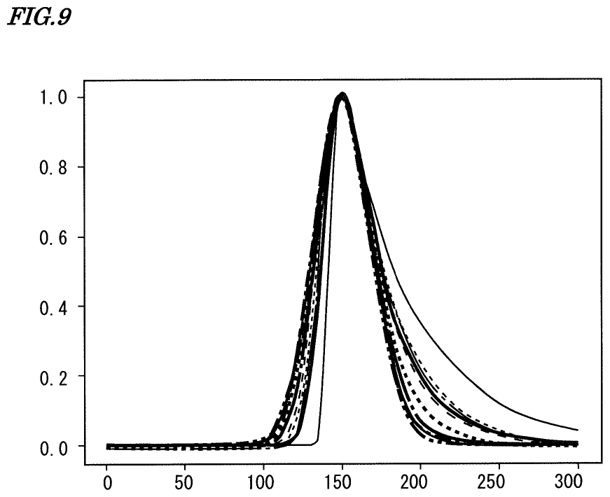

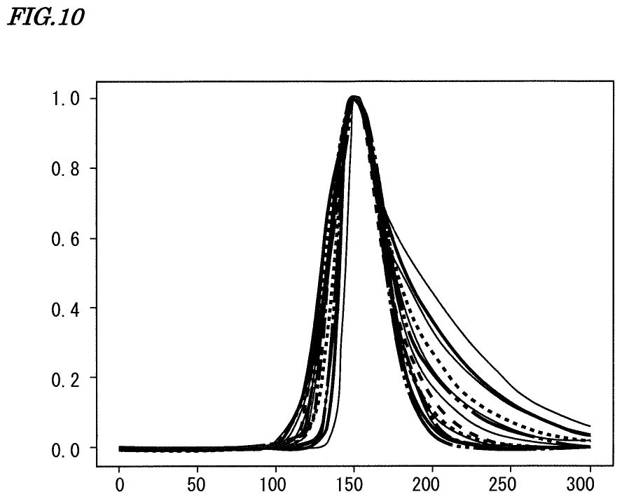

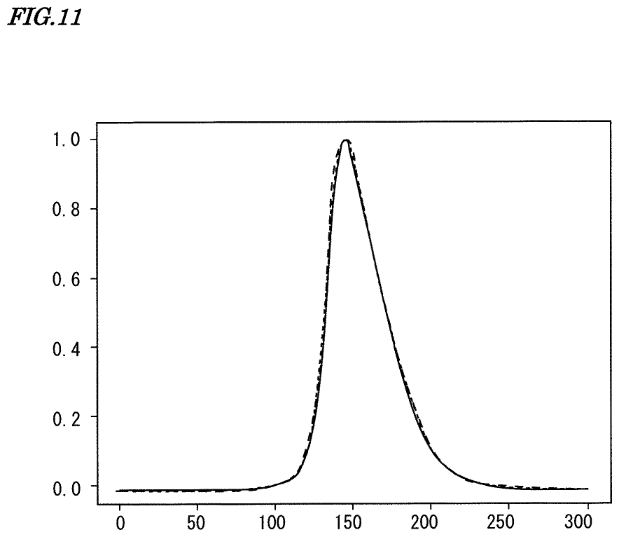

With a generative model using a generative adversarial network (GAN), it is possible to generate waveform data by providing any latent variable. However, there is a problem that a model using a GAN causes mode collapse in a learning process. The measurement data for training as shown in FIG. 9 is used in the following description by way of example. The training data shown in FIG. 9 includes 16 peak waveforms having different degrees of tailings. FIG. 10 shows the waveform data generated by a generative model obtained when training using a GAN is performed relatively well. The waveform data shown in FIG. 10 is the data generated when 100 data pieces that have been sampled in a normal distribution are provided to the trained generative model as latent variables. In contrast, FIG. 11 shows the waveform data generated by a generative model that has been trained by a GAN that has caused mode collapse. Similarly, the waveform data shown in FIG. 11 is the data generated when 100 data pieces that have been sampled in a normal distribution are provided to the trained generative model as latent variables. In FIG. 11, since distorted training is performed due to mode collapse, the generated waveform data follows only part of the training data. In contrast, with each of the waveform shape learning devices 1, 1A, 1B of the present embodiment, since such mode collapse caused by a GAN does not occur, it is possible to construct a generative model in which training data is correctly reflected.

### 7. MODIFIED EXAMPLES OF EMBODIMENTS

Each of the waveform shape learning devices 1, 1A, 1B functions as a model function estimation device, by way of example. In another embodiment, a model function estimation device may be configured as another device by extraction of the waveform data generator 24 from each of the trained waveform shape learning device 1, 1A, 1B. In this case, in addition to the waveform data generator 24, the model function estimation device may include an estimator that performs Bayesian inference or the like.

In each of the above-mentioned embodiments, the data obtained by extraction of a peak portion from measurement data MD is used as input data Y received by the latent variable generator 23. That is, time-series data representing a waveform is used as the input data Y. In another embodiment, various features calculated based on time-series data representing a waveform may be utilized as the input data Y. In this case, the comparer 25 compares a feature of time-series data received by the latent variable generator 23 with a feature of waveform data WD output from the waveform data generator 24. Alternatively, in addition to the time-series data representing a waveform, a feature of the time-series data may be input to the latent variable generator 23.

Desirably, more stable learning is expected by inclusion of an extended feature such as a smoothed derivative or a smoothed second-order derivative obtained by a Savitzky-Golay filter in the input data Y. Further, moments may be calculated as features with which the width, kurtosis, skewness and the like of a peak shape can be calculated, and the input data Y may include these features. In particular, in a case in which a feature that is to be integrated in a time direction, such as a moment, is used, there is an advantage that a network independent of the number of data points (the number of vector dimensions) of the input data Y and the waveform data WD can be constructed. Similarly, also in regard to the encoder 231, a latent variable distribution may be created based on a peak feature such as a moment, instead of creation of a distribution of a latent variable Z directly based on time-series data (waveform).

In the second and third embodiments, the time step count T for designating the number of dimensions of the waveform data WD is provided to the waveform data generator 24. In addition to designation of a value directly designating the number of dimensions, information equivalent to the time step count T that can determine the dimensions of the waveform data WD may be provided.

In each of the above-mentioned embodiments, the time distortion function D (t, Z) is generated by addition of a sigmoid function for application of a unimodal restriction. In another example, a function having monotonicity and other than the sigmoid function can be used. Alternatively, D(t, Z) may be calculated by generation of a derivative time distortion function dD(t, Z) that outputs a slope at each point in time of the time distortion function D(t, Z) as a positive value and then numerical integration. Alternatively, a slope β of the time distortion function D(t, Z) and a slope change rate dd(t, Z) of a positive value at each point in time may be used.

If the same number of points in a time axis direction are set for a comparison process by the comparer 25, general neural networks can be utilized as for the encoder 231 and the waveform data generator (decoder) 24. Further, the encoder 231 and the waveform data generator (decoder) 24 may be applied to a waveform having any length using Deep Set or the like.

Each of the waveform shape learning devices 1, 1A, 1B of the present embodiment have a structure similar to that of a variational autoencoder (VAE). In regard to learning, the VAE generally controls a distribution of Z using a KL distance or the like. In the above-mentioned embodiment, more preferably, Z is set to a multidimensional normal distribution. Thus, the waveform data generator 24 can be utilized as a function that converts a normal distribution into a waveform distribution, and can be used as a peak shape prior distribution when peak fitting is solved by Bayesian inference. Further, with a loss function of a normal VAE, input data is compared to directly corresponding converted waveform data. However, in actual training, training is performed for each batch, and training is performed with respect to an average gradient. As such, in the above-mentioned embodiment, a loss function that causes statistical features per batch to match so that the distribution of each feature of input data Y matches the distribution of waveform data WD. Further, distribution generation by the VAE is intended to be utilized as a technique for calculation of a KL distance when Z is set to a specific distribution shape, and also intended to smooth the relationship between a change in Z and a change in output value of a loss function. Therefore, it is considered that the device of the present embodiment is implemented as an autoencoder not having the latent variable generator 23 and is implemented to have an additional restriction for smoothing the relationship between Z and a loss function.

In the above-mentioned embodiment, the program P1 can perform the waveform shape learning method and the model function estimation method, by way of example. That is, the program P1 includes the waveform shape learning program and a model function estimation program, by way of example. In another embodiment, a program for executing the model function estimation method may be a program different from the waveform shape learning program.

### 8. ASPECTS

It will be appreciated by those skilled in the art that the exemplary embodiments described above are illustrative of the following aspects.
(Item 1) A waveform shape learning device according to one aspect that learns a waveform of a sample using measurement data of the sample, the measurement data being obtained in an analysis device, includes an extractor that retrieves the measurement data stored in a storage device and extracts input data from the measurement data, a latent variable generator that outputs, based on the input data, a latent variable by which the input data is characterized, a waveform data generator that outputs waveform data based on the latent variable and stores the waveform data in the storage device, a comparer that compares, using a loss function, the input data and the waveform data that are stored in the storage device, and a trainer that optimizes the latent variable generator and the waveform data generator so that output of the loss function is minimized.

It is possible to construct a highly convenient generative model of waveform data by appropriately learning measurement data.
(Item 2) The waveform shape learning device according to item 1, wherein the latent variable generator and the waveform data generator may include neural networks.

It is possible to construct a generative model by optimization of a neural network.
(Item 3) The waveform shape learning device according to item 1 or 2, wherein a time step count designating a dimension count of the waveform data may be provided to the waveform data generator, and the waveform data generator may output the waveform data based on the latent variable and the time step count.

It is possible to designate a dimension count of waveform data generated by the waveform data generator.
(Item 4) The waveform shape learning device according to item 1 or 2, wherein the latent variable generator may apply a restriction so that the latent variable is a specific distribution.

Waveform data can be near input data.
(Item 5) The waveform shape learning device according to item 1 or 2, wherein the waveform data generator may apply a unimodal restriction to a waveform of the waveform data.

It is possible to generate a peak waveform as waveform data.
(Item 6) The waveform shape learning device according to item 1 or 2, wherein the latent variable generator may receive time-series data extracted from the measurement data and/or a feature of the time-series data as the input data, and the comparer may compare time-series data and/or a feature of the time-series data with the waveform data and/or a feature of the waveform data.

It is possible to improve the effect of learning.
(Item 7) The waveform shape learning device according to item 1 or 2, wherein the latent variable generator may receive, as the input data, a peak feature acquired from the measurement data or a moment which is a basis for the peak feature.

It is possible to improve the effect of learning.
(Item 8) A model function estimation device may estimates, using the waveform data generator that has been trained in the waveform shape learning device according to item 1 or 2, a model function of measurement data subject to estimation, wherein the waveform data generator may output, based on the latent variable provided as a prior distribution, the waveform data, and the model function estimation device may fit the waveform data to the measurement data subject to estimation by optimizing the latent variable.

It is possible to generate waveform data to be fitted to measurement data.
(Item 9) A waveform shape learning method according to another aspect of learning a waveform of a sample using measurement data of the sample, the measurement data being obtained in an analysis device, includes retrieving the measurement data stored in a storage device and extracting input data from the measurement data, a latent variable generating step of outputting, based on the input data, a latent variable by which the input data is characterized, a waveform data generating step of outputting waveform data based on the latent variable and storing the waveform data in the storage device, comparing, using a loss function, the input data and the waveform data that are stored in the storage device, and optimizing the latent variable generating step and the waveform data generating step so that output of the loss function is minimized.

It is possible to construct a highly convenient generative model of waveform data by appropriately learning measurement data.
(Item 10) A non-transitory computer readable medium storing a program according to another aspect learns a waveform of a sample using measurement data of the sample, the measurement data being obtained in an analysis device, wherein the program causes a computer to execute a process of retrieving the measurement data stored in a storage device and extracting input data from the measurement data, a latent variable generating process of outputting, based on the input data, a latent variable by which the input data is characterized, a waveform data generating process of outputting waveform data based on the latent variable and storing the waveform data in the storage device, a process of comparing, using a loss function, the input data and the waveform data that are stored in the storage device, and a process of optimizing the latent variable generating process and the waveform data generating process so that output of the loss function is minimized.

It is possible to construct a highly convenient generative model of waveform data by appropriately learning measurement data.

While preferred embodiments of the present disclosure have been described above, it is to be understood that variations and modifications will be apparent to those skilled in the art without departing the scope and spirit of the present disclosure. The scope of the present disclosure, therefore, is to be determined solely by the following claims.

I/We claim:

1. A waveform shape learning device that learns a waveform of a sample using measurement data of the sample, the measurement data being obtained in an analysis device, comprising:
an extractor that retrieves the measurement data stored in a storage device and extracts input data from the measurement data;
a latent variable generator that outputs, based on the input data, a latent variable by which the input data is characterized;
a waveform data generator that outputs waveform data based on the latent variable and stores the waveform data in the storage device;
a comparer that compares, using a loss function, the input data and the waveform data that are stored in the storage device; and
a trainer that optimizes the latent variable generator and the waveform data generator so that output of the loss function is minimized.

2. The waveform shape learning device according to claim 1, wherein the latent variable generator and the waveform data generator include neural networks.

3. The waveform shape learning device according to claim 1, wherein
a time step count designating a dimension count of the waveform data is provided to the waveform data generator, and the waveform data generator outputs the waveform data based on the latent variable and the time step count.

4. The waveform shape learning device according to claim 1, wherein
the latent variable generator applies a restriction so that the latent variable is a specific distribution.

5. The waveform shape learning device according to claim 1, wherein
the waveform data generator applies a unimodal restriction to a waveform of the waveform data.

6. The waveform shape learning device according to claim 1, wherein
the latent variable generator receives time-series data extracted from the measurement data and/or a feature of the time-series data as the input data, and the comparer compares time-series data and/or a feature of the time-series data with the waveform data and/or a feature of the waveform data.

7. The waveform shape learning device according to claim 1, wherein
the latent variable generator receives, as the input data, a peak feature acquired from the measurement data or a moment which is a basis for the peak feature.

8. A model function estimation device that estimates, using the waveform data generator that has been trained in the waveform shape learning device according to claim 1, a model function of measurement data subject to estimation, wherein
the waveform data generator outputs, based on the latent variable provided as a prior distribution, the waveform data, and
the model function estimation device fits the waveform data to the measurement data subject to estimation by optimizing the latent variable.

9. A waveform shape learning method of learning a waveform of a sample using measurement data of the sample, the measurement data being obtained in an analysis device, including:
retrieving the measurement data stored in a storage device and extracting input data from the measurement data;
a latent variable generating step of outputting, based on the input data, a latent variable by which the input data is characterized;
a waveform data generating step of outputting waveform data based on the latent variable and storing the waveform data in the storage device;
comparing, using a loss function, the input data and the waveform data that are stored in the storage device; and
optimizing the latent variable generating step and the waveform data generating step so that output of the loss function is minimized.

10. A non-transitory computer readable medium storing a program that learns a waveform of a sample using measurement data of the sample, the measurement data being obtained in an analysis device,
the program causing a computer to execute:
a process of retrieving the measurement data stored in a storage device and extracting input data from the measurement data;
a latent variable generating process of outputting, based on the input data, a latent variable by which the input data is characterized;
a waveform data generating process of outputting waveform data based on the latent variable and storing the waveform data in the storage device;
a process of comparing, using a loss function, the input data and the waveform data that are stored in the storage device; and
a process of optimizing the latent variable generating process and the waveform data generating process so that output of the loss function is minimized.
